(19) United States
(12) Patent Application Publication
(10) Pub. No.: US 2005/0055495 A1
(43) Pub. Date: Mar. 10, 2005

(54) Memory wear leveling

(75) Inventors: Jukka-Pekka Vihmalo, Tampere (FI); Marko T. Ahvenainen, Ruutana (FI); Jakke Makela, Turku (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/656,888

(22) Filed: Sep. 5, 2003

(51) Int. Cl. G06F 12/16

(52) U.S. Cl. 711/103; 711/154

(57) ABSTRACT

This invention describes a memory wear leveling for reducing wearing of hotspots (deteriorated memory blocks used more frequently) in all memory types by rotating the memory blocks on the physical level with the help of at least one spare memory block using predetermined criteria during both read and write operations. The invention can be implemented e.g. by using constant memory pointers at a logical level and dynamic memory pointers on the physical level. The rotation can be implemented as a combination of software and hardware functionalities or using hardware or software alone.

### FIELD OF THE INVENTION

This invention generally relates to a memory wear leveling and more specifically to reducing wearing of hotspots (memory blocks used more frequently) by rotating the memory blocks on the physical level based on predetermined criteria using at least one spare memory block.

### BACKGROUND OF THE INVENTION

Conventional memories (e.g. flash memories) deteriorate somewhat on each write operation (destructive write). This may cause problems if certain memory areas are written more often than other areas. This problem can be solved by maintaining registers that count the number of write operations performed for each memory block. The least used block is then selected as the next block to be used when data is written (so called “wear leveling”). Solutions for wear levelling are used, for example, in flash memories. These implementations typically use tables to store usage of given sectors. Typically, there are some spare blocks, which can be taken into use, and old blocks (memory blocks that have been written too many times) can be removed from use (i.e. marked as “not in use”) as they wear out. An example of such wear management approach for the write operation during memory usage can be found in U.S. Pat. No. 6,405,323, “Defect Management for Interface to Electrically-Erasable Programmable Read-Only Memory”, by F. F-L. Lin et al.; U.S. Pat. No. 5,568,423, “Flash Memory Wear Leveling System Providing Immediate Direct Access to Microprocessor”, by E. Jou, et al.; and U.S. Pat. No. 6,230,233, “Wear Leveling Techniques for Flash EEPROM Systems”, by K. M. J. Lufgren et al. Cache routines can also be used to solve this problem as described in US Patent Application No. 20010002475 “Memory Device” by L. I. Bothwell et al. Although technologies with destructive writes can be handled relatively easily with existing wear leveling algorithms, the same methods cannot be used for technologies with destructive reads discussed below.

Ferro-electric memories (FeRAM) are based on various ferroelectric compounds, e.g. a Perovskite compound Pb(Zr,Ti)O₃ (PZT). The ability of a ferroelectric crystal to switch between its polarization states and to make a small area of reversed domains with fast switching has made ferroelectrics attractive for high capacity nonvolatile memories and data storage. The information can be written and read very fast requiring very little power; however, it has a limited life and suffers from a destructive read because of a fatigue factor, which is a degradation of the polarization hysteresis characteristic with increasing number of cycles. This is the most serious problem of ferroelectric memory devices in non-volatile memory applications. From a practical point of view, a lifetime (that is, the time until the polarization degradation is observed) of well over 10¹⁵ cycles is required which cannot be met by the current state-of-the-art ferroelectric memory technologies. The wear-leveling problem is thus expanded to read operations as well. The destructive read characteristic is a problem especially in hotspots. A hotspot is a memory block that is accessed significantly more often than memory blocks that are accessed on average. These hotspots are a problem when the memory read and/or write endurance is limited, which is the case with most solid-state nonvolatile memories.

There are several approaches to solving this problem for the read operation during memory usage. US Patent Application No. 20030058681, “Mechanism for Efficient Wearout Counters in Destructive Readout Memory”, by R. L. Coulson, published Mar. 27, 2003, presents a method utilizing wearout counters somewhat similar to those used in conventional memories for the write operation. US Patent Application No. 20010054165, “Memory Device Having Redundant Cells”, by C. Ono, published Dec. 20, 2001, describes a method utilizing redundant memory blocks as spare blocks for blocks that wear out. All of these methods require counting of access activities which increases overall complexity and overhead. EP Patent No. 0741388, “Ferro-Electric Memory Array Architecture and Method for Forming the Same”, by J-D. D. Tai, published Nov. 6, 1996, discloses an architecture that reduces the number of memory cells being accessed in a read operation.

### SUMMARY OF THE INVENTION

The object of the present invention is to provide a memory wear leveling methodology for reducing wearing of hotspots, i.e., frequently used memory blocks, in all memory types.

The hotspots are “smoothed out” by rotating the memory blocks on the physical level with the help of a spare memory block. This simple principle is illustrated by the example below, wherein 1,2,3,4 . . . represent memory blocks and s represents the spare block. Then during each read operation the spare block switches places with the neighboring memory block as follows:
1234567890s,
123456789s0,
12345678s90,
1234567s890,
   and so on. The present invention uses a blind approach in which no information about the actual memory usage is needed.

More generally, according to a first aspect of the present invention, a method for wear leveling of a multi-block memory containing data, usable in multi-block memory activities, comprises the steps of: detecting an at least one triggering signal; and copying or relocating the data of an at least one first memory block containing an at least one memory element of the multi-block memory to an at least one second memory block of the multi-block memory after detecting the at least one triggering signal, wherein said at least one second memory block does not contain said data before said copying or relocating. Further, each of the at least one first memory block and the at least one second memory block may contain only one memory element. Still further, there may be more than one memory element contained in the at least one first memory block and there may be more than one memory element contained in the at least one second memory block, respectively.

In further accord with the first aspect of the invention, the method may further comprise the step of updating a first memory pointer originally pointed to the at least one second memory block before said copying or relocating to point to the at least one first memory block after said copying or relocating. Still further, the method may further comprise the step updating a second memory pointer by shifting it back to a physical zero point by reducing the value of the second memory pointer by a number of relocated memory elements of the second memory block if the first memory pointer is pointing to one of the memory elements of the at least one second memory block after said updating.

Still further according to the first aspect of the invention, the data of an at least one additional block of the multi-block memory may be relocated to an at least one further additional block of the multi-block memory after detecting the at least one triggering signal, wherein said at least one further additional block does not contain the data before said relocation.

Further still according to the first aspect of the invention, said copying or relocating may be performed according to predetermined criteria. Further, said predetermined criteria may enable said copying or relocating of a regular pattern such that after a predetermined number of triggering signals copying or relocating steps are identical. Still further, said predetermined criteria may enable said copying or relocating of a random pattern such that after any number of triggering signals, copying or relocating steps are not necessarily identical.

In further accordance with the first aspect of the invention, said copying or relocating of the data may occur only after detecting a predetermined number of the at least one triggering signal.

Yet further still according to the first aspect of the invention, the at least one triggering signal may correspond to a read operation, to a write operation, to a time clock pulse or to the detection of a predetermined number of read/write operations or clock pulses.

According further to the first aspect of the invention, said copying or relocating of the data may occur a predetermined number of times between the triggering signals According still further to the first aspect of the invention, the method may further comprise the step of counting the usage of the individual memory blocks of the multi-block memory, wherein said copying or relocating is performed according to predetermined criteria, said predetermined criteria includes considerations for said counting.

According further still to the first aspect of the invention, all the data contained in the multi-block memory may be copied or relocated at the same time.

Yet still further according to the first aspect of the invention, the method may further comprise the step of updating a variable logical address X after said copying or relocating in the multi-block memory containing C memory elements, said variable logical address X for said C memory elements identified by pointers X₀, X₁ . . . Xₖ, Xₖ₊₁ . . . X_{C-1} is updated to an updated variable logical address Xᵤ for C-S memory elements identified by the pointers X₀, X₁ . . . Xₖ₋₁, X_{k+S} . . . X_{C-1}, wherein C is a total number of the memory elements of the multi-element memory, S is a number of the memory elements identified by the pointers Xₖ, Xₖ₊₁, X_{k+S-1} in a spare memory block after said copying or relocating, wherein a first element of said first memory block after said copying or relocating corresponds to a first element identified by the pointer Xk of the spare memory spare block after said copying or relocating.

According to a second aspect of the invention, an electronic device, comprises: a multi-block memory containing data, usable in multi-block memory activities; a memory wear controller, responsive to a triggering signal or to a further triggering signal, for providing a data-relocation signal to the multi-block memory to relocate the data from an at least one first memory block containing an at least one memory element of the multi-block memory to an at least one second memory block of the multi-block memory wherein said at least one second memory block does not contain said data before said copying or relocating, and for providing an update signal after performing said copying or relocating; and a memory pointer controller, responsive to the update signal. Further, each of the at least one first memory block and the at least one second memory block may contain only one memory element. Still further, there may be more than one memory element contained in the at least one first memory block and there may be more than one memory element contained in the at least one second memory block, respectively.

According further to the second aspect of the invention, the memory pointer controller may provide a pointer signal to the memory wear controller based on predetermined criteria. Further, the memory pointer signal may contain a physical address in the multi-block memory to be accessed for enabling an at least one further data relocation of the data located at the physical address and optionally an address of a first memory pointer.

Further according to the second aspect of the invention, the memory pointer controller may provide updating of at least one memory pointer pointing to said first memory block before said copying or relocating to point to said second memory block after said copying or relocating.

Further still according to the second aspect of the invention, the memory wear controller and the memory pointer controller may be implemented as software, hardware, or a combination of software and hardware components. Further, the hardware may be implemented using a finite state machine.

In further accord with the second aspect of the invention, said copying or relocating of the data from the at least one first memory block and updating the location of the memory pointers may be performed according to predetermined criteria.

Further still according to the second aspect of the invention, the electronic device may further comprise a triggering detector, responsive to the triggering signal, for providing a further triggering signal upon detecting the triggering signal.

In further accordance with the second aspect of the invention, the electronic device may further comprise of a triggering detector, responsive to the triggering signal, for providing a further triggering signal upon detecting the triggering signal.

According to a third aspect of the invention, an electronic device comprises: means for containing data in multiple memory blocks, wherein said data is usable in activities of the means for containing data; means for providing a data-relocation signal to the means for containing the data for copying or relocating the data from an at least one first memory block containing an at least one memory element of the means for containing the data to an at least one second memory block of the means for containing the data in response to a triggering signal, wherein said at least one second memory block does not contain said data before said copying or relocating, and for providing an update signal on a status of the means for containing the data after performing said copying or relocating; and means for providing to the means for providing the data-relocation signal, in response to the update signal, a pointer signal containing a physical address pointer in means for containing data to be accessed for enabling an at least one further data relocation of the data located at the physical address and optionally an address of a first memory pointer. Further, the means for providing to the means providing the data-relocation signal may further provide updating of at least one memory pointer pointing to said first memory block before said copying or relocating to point to said second memory block after said copying or relocating.

According to a fourth aspect of the invention, a method for wear leveling of a multi-block memory containing data, usable in multi-block memory activities, comprises copying or relocating the data from an at least one first block containing an at least one memory element of the multi-block memory to an at least one second block containing an at least one memory element of the multi-block memory after detecting a triggering signal related to said data, wherein said at least one second block does not contain said data before said copying or relocating. Further, an at least one memory pointer pointing to said first memory block before said copying or relocating may be updated to point to said second memory block after said copying or relocating.

### BRIEF DESCRIPTION OF THE DRAWINGS

For a better understanding of the nature and objects of the present invention, reference is made to the following detailed description taken in conjunction with the following drawings, in which:

FIGS. 1a, 1b, 1c, and 1d together illustrate the concept of a multi-block memory wear leveling, according to the present invention.

FIGS. 2a, 2b and 2c together further illustrate the concept of a multi-block memory wear leveling comparing an actual memory space with a memory space seen by a user, according to the present invention.

FIG. 3 is a block diagram representing a system for implementing a memory wear leveling, according to the present invention.

FIG. 4a shows a flow chart for general implementation of a memory wear leveling, according to the present invention.

FIG. 4b shows a flow chart of simplified Y-implementation procedure for general implementation of a memory wear leveling of FIG. 3a, according to the present invention.

FIG. 5 shows a flow chart for special implementation of a memory wear leveling with S=1, according to the present invention.

FIG. 6 is a block diagram representing a hardware implementation of a memory wear leveling, according to the present invention.

### BEST MODE FOR CARRYING OUT THE INVENTION

To assist in clarifying the technical subject matter of this invention, a few symbols are defined in Table 1 and further described in the text.

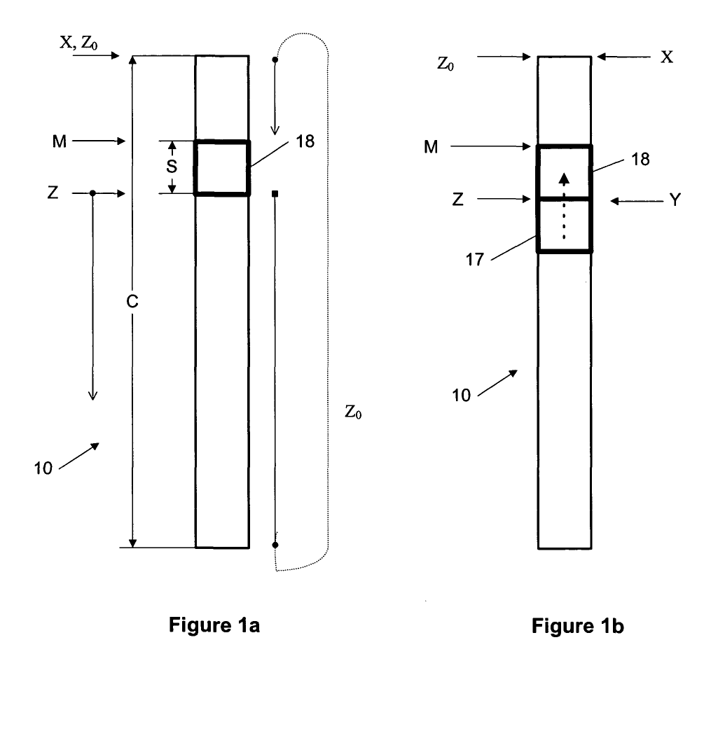

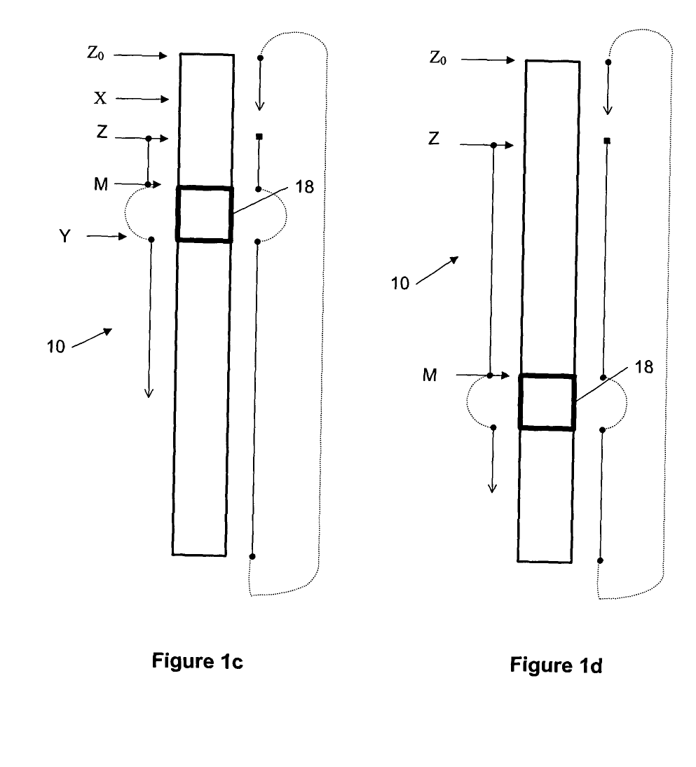

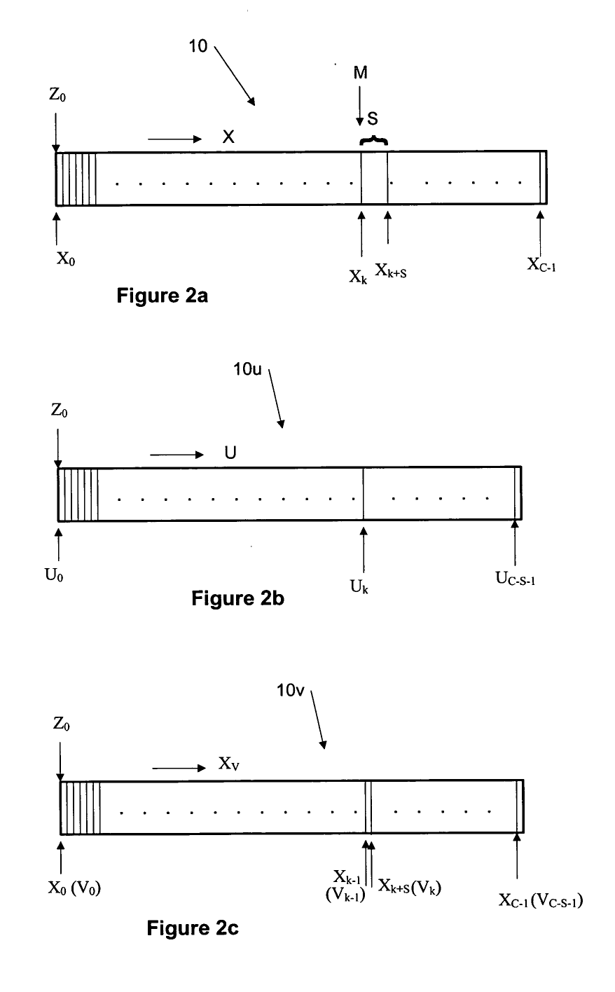

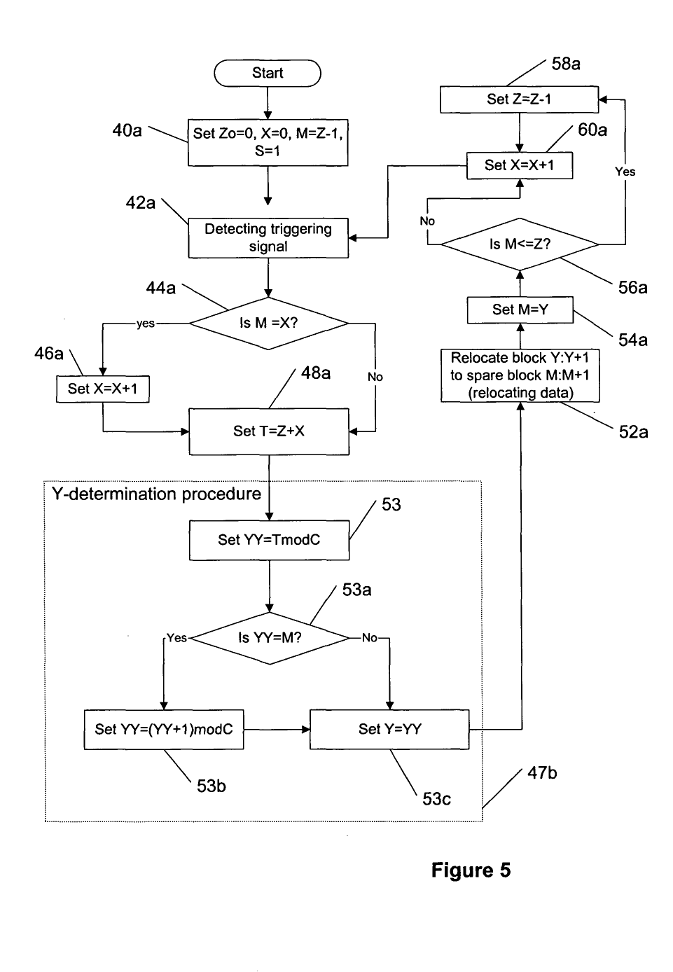

TABLE 1

| | | Reference |
|---|---|---|
| Symbol | Description | FIG. |
| Z₀ | A physical zero address/pointer, which is | FIGS. |
| | always zero and pointing to the first memory | 1a-1d, |
| | element of the memory space 10 or 10u. | FIG. |
| | | 2a-2c. |
| Z | A logical zero address/pointer; it is also called | FIGS. |
| | a second memory pointer. | 1a-1d, |
| M | A spare block address/pointer; it is also called a | FIGS. |
| | first memory pointer. | 1a-1d, |
| | | FIG. 2a. |
| C | A size of the memory 10 (a total number of the | FIG. 1a. |
| | memory elements). | |
| S | A size of the spare memory block 18 (a total | FIG. 1a. |
| | number of the memory elements in the spare | |
| | block). | |
| X | A variable logical address of a memory element | FIGS. |
| | in the actual memory 10. | 1b-1c, |
| | | FIG. 2a. |
| X₀, | Logical pointers of the memory elements in the | FIG. 2a. |
| X₂, . . . X_{C-1} | memory 10. | |
| U | A variable logical address of a memory element | FIG. 2b. |
| | in the memory space 10u seen by the user. | |
| U₁, | Logical pointers of the memory elements in the | FIG. 2b. |
| U₂ . . . Uₖ | memory space 10u seen by the user. | |
| X_{V} | An updated variable logical address of a | FIG. 2c. |
| | memory element in the virtual memory space | |
| | 10v. | |
| V₁, | Logical pointers of the memory elements in the | |
| V₂ . . . Vₖ | virtual actual memory space 10v. | |
| Y | A variable physical address/pointer of a | FIGS. |
| | memory element in the memory 10; it points | 1b-1c. |
| | to the first element of a memory block (e.g., | |
| | block 17) to be relocated to a spare block | |
| | (e.g., block 18). | |
| T | A variable used for calculating Y. | FIGS. |
| | | 4a, 4b, 5. |
| YY | A variable used for calculating Y. | FIG. 5. |

This invention describes a memory wear leveling for reducing wearing of hotspots (memory blocks used more frequently) in all memory types by rotating the memory blocks on the physical level with the help of at least one spare memory block using predetermined criteria during or after read and/or write operations. The hotspots are smoothed out by this rotation. The present invention uses a blind approach in which no information about the actual memory usage is needed. The invention can be implemented, for example, by using constant memory pointers at a logical level and dynamic memory pointers on the physical level. The rotation can be implemented as a combination of software and hardware functionalities. For example, the physical rotation can be handled independently by a memory management hardware module, whereas logical and physical addresses are associated by a software method that calculates the physical address on the basis of the logical address and memory parameters. Another implementation alternative is using hardware for both memory rotation and address management. In this case, the hardware maintains the correct associations between the logical and physical addresses.

The advantages of the present invention are simplicity and a smaller overhead (i.e. memory reserved for memory management). Using counter registers as in conventional solutions for the write operation will result in a more complex memory management scheme than the present invention.

FIGS. 1a through 1d together show an example illustrating the concept of a multi-block memory 10 wear leveling, according to the present invention. A linear combination of memory blocks is chosen in FIGS. 1a through 1d for this illustrative example, but the memory 10 can also be represented by a “circular” combination of blocks as partial segments of a circle. The general case is in principle a straightforward extension of the preferred implementation shown herein, but the general case requires additional steps and considerable complexity with no real advantage over the preferred embodiment.

FIG. 1a shows the initial state of a memory array 10 shown as the linear combination of the memory blocks including, for example, a block 18, wherein C is the total size (a total number of the memory elements) of the multi-block memory 10, M is a spare block address/pointer or a first memory pointer which typically points at the first element of the spare memory block 18 (or the spare block 18), S is a number of memory elements in the spare memory block 18, Z₀ is a physical zero address/pointer, and Z is a logical zero address/pointer or a second memory pointer. A typical memory element has 16 bits or 2 bytes of information, but it can also be a memory cell or an array of memory cells or any other entity capable of containing at least one bit of data. Any memory block of the multi-element memory 10 (including the spare block 18) can contain one or more such memory elements. The physical zero address/pointer Z₀ points to the first available element of the memory 10 in a preferred embodiment (and is therefore by definition equivalent to zero), and it does not change in time. This gives the memory 10 a convenient common reference point independently of the state of rotation.

For the example of FIG. 1a, the spare block 18 is located just behind the logical zero address/pointer Z. The spare block can be a single or a multi-element block. According to the present invention, it is recommended to choose C, Z₀ and Z such that quantities C and Z-Z₀ are divisible by S.

FIG. 1b shows shifting of a first memory block 17 (or block 17) indicated at its start at the first element by a variable physical address/pointer Y to the spare block 18 (or the second memory block 18). Apparently, the blocks 17 and 18 have the same number of memory elements. A variable physical address/pointer Y is determined using a variable logical address X based on the predetermined criteria. According to one embodiment of the present invention, after each data relocation, the variable logical address X is altered by the amount equal to S or a multiple of S. For the presented example, a logical-to-physical memory mapping is given by a relationship Y=Z₀+(Z+X)modC. Since Z₀=0 and if the first value of X=0, then Y=Z₀+Z=Z, which is shown in FIG. 1b. Thus, the block 17 starting at the logical zero address/pointer Z is relocated to the spare block 18. Generally, as evident from the above description, moving of the spare block is effectively done by writing the data of the memory block, which is to become the spare block to the current spare block. Alternately, copying instead of relocating of the content of the block 17 to the block 18 can be used, such that during a further relocating (copying) event, unusable data left in the block 17 (which becomes a new spare block after said previous relocation) is simply overwritten.

FIG. 1c illustrates updating the first and second memory pointers M and Z, respectively, after the block 17 is relocated to the spare block 18 in FIG. 1b. The first memory pointer M as shown in FIG. 1c is moved to a location corresponding to the beginning of the block 17 (last relocated block) before the block 17 was relocated. Thus M again points at the spare memory block. After moving the first memory pointer M, the location of M is the same as the location of the second memory pointer Z in FIG. 1a. The second memory address/pointer Z is then shifted back towards the physical zero address/pointer Z₀ by reducing the value of Z by the amount equal to the number of memory elements in the spare memory block S. A new location of Z is shown in FIG. 1c. Generally, the criteria for updating M and Z after data relocation can be summarized as follows: a) always move M to a starting memory element of a new spare block; and b) move Z by the amount equal to S towards Z₀ in the direction of reducing Z if M=Z or points to any memory element of the relocated block except the first memory element.

The same procedure described in FIGS. 1b and 1c is repeated multiple times by incrementing X by S, which is illustrated in FIG. 1d, until M again reaches Z, at which point Z again becomes switched as shown in FIG. 1c, described herein.

FIGS. 2a, 2b and 2c together further illustrate the concept of a multi-block memory wear leveling comparing an actual memory space with a memory space seen by a user and a virtual actual memory space, according to the present invention. FIG. 2a shows the actual physical memory space of the memory 10 after a relocation memory event described herein. It consists of C memory elements indicated by logical pointers X₀, X₁ . . . Xₖ . . . X_{C-1}. The spare memory block includes S memory elements indicated by the logical pointers Xₖ through X_{k+S-1}, with the pointer M pointing at the first element Xₖ of the spare memory block. FIG. 2b shows the memory space 10u seen by the user. It consists of C-S memory elements indicated by logical pointers U₀, U₁ . . . Uₖ . . . U_{C-S-1}. The user does not see any of the spare blocks moving activity and the address space is totally constant and contiguous is far as the user is concerned. Thus, when the user specifies a variable logical address U indicated by the logical pointer Uₖ in the memory space 10u, the variable logical address X of the memory element in the memory space 10 is determined as follows:
X=U if k<M, (1)
X=S+U if k≧M. (2)

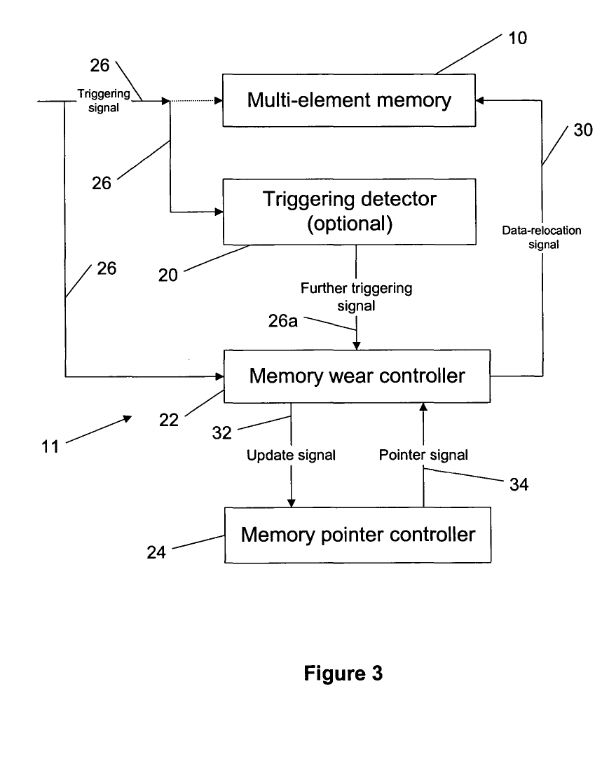

The above relationship is important for establishing connection between memory spaces 10 and 10u and for the practical implementation of the present invention. This concept is further developed in FIG. 2c showing a virtual actual memory space 10v with an updated variable logical address X_{V} recalculated using Equations 1 and 2 with X_{V}=X every time after a memory block relocation event described herein. The virtual actual memory space 10v contains C-S memory elements identified by pointers X₀, X₁, . . . Xₖ₋₁, X_{k+S}, . . . X_{C-1}, which is identical to the elements in the memory space 10u seen by the user. The elements identified by the pointers X₀, X₁, . . . Xₖ₋₁ in the memory space 10v correspond to the elements U₀, U₁, . . . Uₖ₋₁ in the memory space 10u, and the elements identified by the pointers X_{k+S}, X_{k+S+1} . . . X_{C-1} in the memory space 10v correspond to the elements Uₖ, Uₖ₊₁ . . . U_{C-S-1} in the memory space 10u, respectively. FIG. 2c also shows (in parentheses) a new set of logical pointers V₀, V₁ . . . Vₖ . . . V_{C-S-1} in the virtual memory space 10v, such that the virtual memory space 10v simulates the memory space 10u seen by the user. If, for example, after a subsequent relocation event the spare memory block is indicated by logical pointers X_{k+S} through X_{k+2S-1}, the virtual actual memory space 10v will contain C-S memory elements identified by pointers X₀, X₁, . . . X_{k+S-1}, X_{k+2S}, . . . X_{C-1} again identical to the elements in the memory space 10u seen by the user FIG. 3 is a block diagram representing a system or an electronics device 11 for implementing a memory wear leveling, according to the present invention. Generally, the system 11 consists of a multi-block memory 10 containing data and responsive to a triggering signal 26 related to the data. A triggering event causes the triggering signal 26 to be activated. Such a triggering event can be a read or write operation or a clock pulse. Alternatively, the triggering event may be the occurrence of a counter reaching a certain value, the counter counting, for example, read/write operations or clock pulses. Alternatively, the triggering event can be some other occurrence that is dependent or independent of the data.

As shown in FIG. 3, a triggering detector 20 (optional) is also responsive to the triggering signal 26, and upon detecting said triggering signal 26 provides a further triggering signal 26a to a memory wear block 22. The memory wear controller 22 provides a data-relocation signal 30 for enabling the data relocation to a spare block according to the predetermined criteria as described in the example of FIGS. 1a through 1d. The memory wear controller 22 also provides an update signal 32 on a status of the multi-block memory 10 after performing said relocation to a memory pointer controller 24. The status information includes new locations of the first memory pointer M after the relocation.

In general, the memory wear controller 22 provides a data-relocation signal 30 to the multi-block memory 10 in response to the further triggering signal 26a, which corresponds to the triggering signal 26 or it can respond directly to the triggering signal 26 if the triggering detector 20 is not used. However, according to the present invention, there are many variations. For example, the data-relocation signal 30 can be sent only after detecting a predetermined number (e.g., more than one) of the triggering signals 26 or the further triggering signal 26a. Alternatively, the data-relocation signal 30 can be sent a predetermined number of times between the triggering signals 26 or the further triggering signal 26a. It is also possible that the triggering signal 26 is only conveyed to the triggering detector 20 and not to the multi-element memory 10.

The memory pointer controller 24, in response to the update signal 32, provides a pointer signal 34 to the memory wear controller 22. Said pointer signal 34 contains a physical addresses Y and optionally M in the multi-block memory 10 based on the predetermined criteria to be accessed for enabling at least one further data relocation of the data located at the physical address Y as described in the example of FIGS. 1a through 1d. The predetermined criteria includes considerations discussed in regard to FIGS. 2a-2c and Equations 1 and 2. The first and second memory address/pointers M and Z, respectively, are updated internally in the memory pointer controller 24 after each memory block relocation. The address M can be incorporated in the pointer signal 34 depending on the system implementation, e.g., if the block 22 does not update and hold information on M by itself. In addition the address M can be incorporated in the pointer signal 34 to provide a redundant protection (e.g., if the current value of M was lost in the block 22 because of the power failure, etc.) for increasing overall system robustness and reliability.

The predetermined criteria which enables a relocation of data as disclosed in the present invention can have many variations. For example, said relocation can have a regular pattern, such that after a predetermined number of triggering signals 26, relocation steps are identical. Said relocation, according to the predetermined criteria, can also have a random pattern, such that after any number of triggering signals 26, relocation steps are not necessarily identical. Furthermore, the method of the memory wear leveling described in the present invention can be used in combination with conventional methods involving counting the usage of individual memory blocks of the multi-block memory 10 such that said predetermined criteria incorporates the counting information.

The triggering detector 20, the memory wear controller 22, and the memory pointer controller 24 of the system 11 shown in FIG. 2 can be implemented as software or hardware components or a combination of software and hardware components.

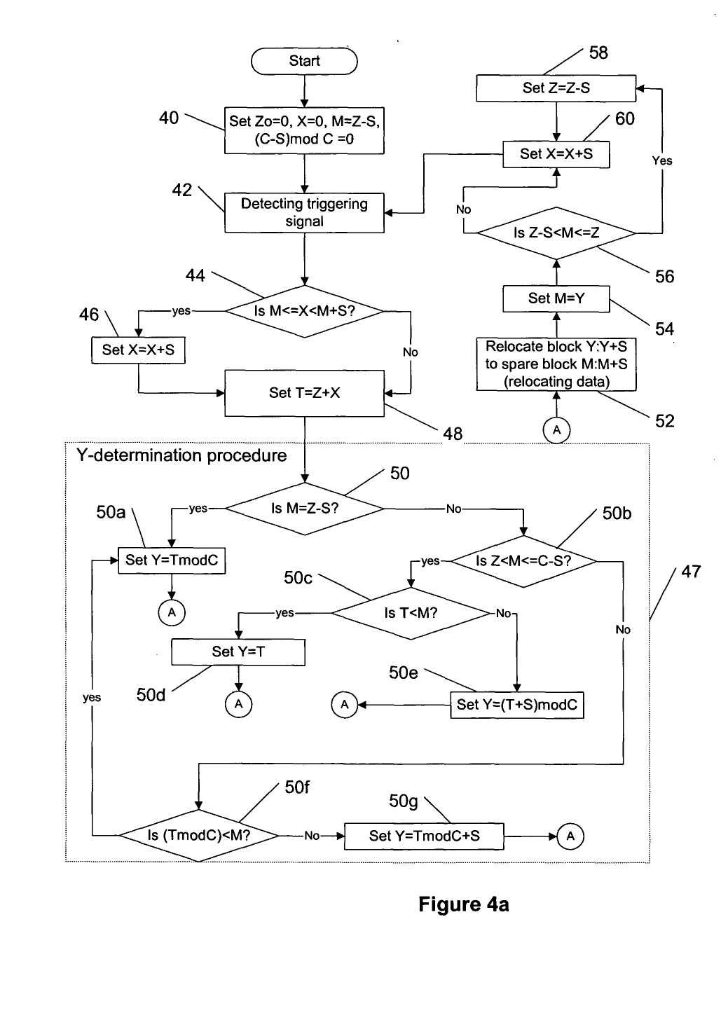

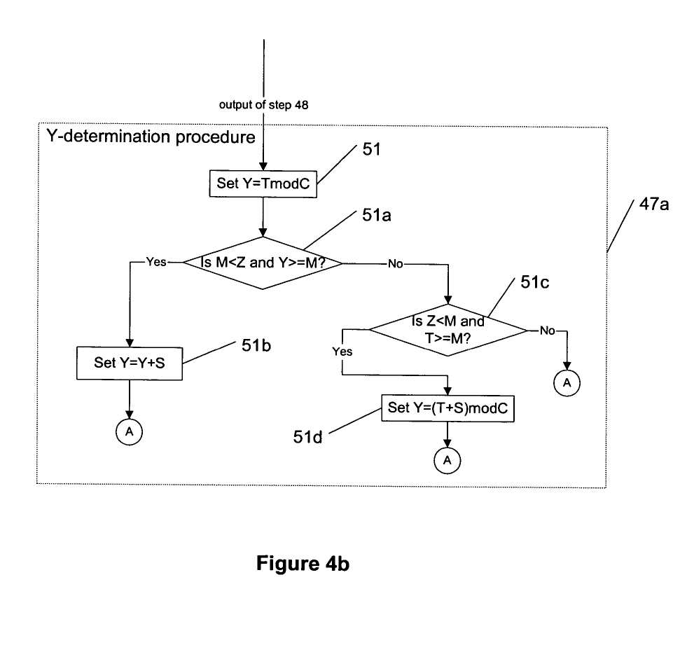

FIG. 4a shows a flow chart, as one example among many others, for a general implementation example of a memory wear leveling, according to the present invention. In a method according to the present invention, in a first step 40, the initial values of parameters are set in the memory pointer controller 24. For example, the following initial parameters are set for this example: Zo=0, X=0, M=Z−S, (C-S)mod C=0. In a next step 42, the triggering signal 26 is detected by the triggering detector 42. Step 42 implies sending signals 28, 30 and 32 as shown in FIG. 3.

In a next step 44, it is ascertained whether the current value of X is pointing at a memory element within the spare block 18. If that is the case, in a next step 46, the value of X is increased by S and the process proceeds to step 48. If, however, the current value of X is not within the spare block, the process proceeds directly to step 48, wherein the value T=X+Z is calculated. A determination of the current value of Y according to the predetermined criteria is performed using Y-determination procedure 47. There are many ways to make this estimation. One general scenario, among many other possibilities, consists of steps 50 through 50g as shown in FIG. 3a. Steps 50, 50b, 50c and 50f are logical operations, performed by the memory pointer controller 24, comparing values of M with parameters Z−S, C−S, T and TmodC as indicated in FIG. 4a, respectively. Steps 50a, 50d, 50e and 50g set respective values of Y based on the decisions made in steps 50, 50b, 50c and 50f.

Steps 50a, 50d, 50e and 50g are followed by a next step 52, in which a block Y:Y+S (e.g., block 17 in FIG. 1b) is relocated to a spare block M:M+S (e.g., block 18 in FIG. 1b). In a next step 54, a new value of M is assigned: M=Y setting a new value for the first memory pointer, as described in regard to FIG. 1c. In a next step 56, it is ascertained whether a current value of M is within the block Z−S:Z. If that is the case, in a next step 58, the value of Z is reduced by S setting a new value for the second memory pointer, as described in regard to FIG. 1c, and the process goes to step 60. If, however, the current value of M is not within the block Z−S:Z, in a next step 60, the value of X is increased by S. After step 60, the process returns to step 42.

FIG. 4b shows a flow chart of a simplified Y-determination procedure 47a for the general implementation of the memory wear leveling of FIG. 3a, according to the present invention. The procedure 47a consisting of steps 50 through 50d is shown in FIG. 3b. Steps 51a and 50c are logical operations performed by the memory pointer controller 34, comparing values of M with parameters Z, Y and T as indicated in FIG. 4b. Steps 51, 51b and 51d set respective values of Y indicated in FIG. 4b based on the decisions made in steps 51a and 50c.

FIG. 5 shows a flow chart of one possible scenario among others for a special case of implementation of a memory wear leveling with S=1, according to the present invention. Steps 40a through 48a and 52a through 60a in FIG. 5 are identical to steps 40 through 48, and 52 through 60 with S=1 in FIG. 3a. Y-determination procedure 47b consisting of steps 53 through 53c is shown in FIG. 4. In a step 53, a new parameter YY is calculated as YY=TmodC. In a next step 53, it is ascertained whether YY is equal to M. If that is the case, in a next step 53b, the value of YY is recalculated as YY=(YY+1)modC, and the process proceeds to step 53c. If, however, YY is not equal to M, in a next step 53c, the value of Y is set to YY.

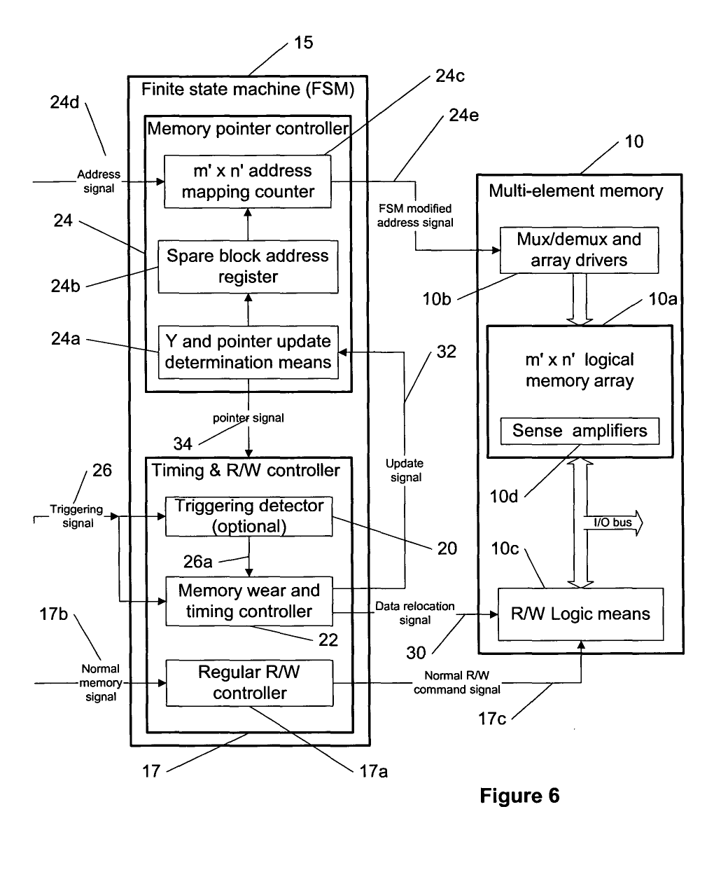

FIG. 6 is a block diagram, as one example among many others, representing a hardware implementation (HW) of the memory wear leveling, according to the present invention. It should be pointed out that any HW implementation is identical at the highest logical level to the software (SW) implementation or combination of HW and SW implementation as described above in regard to FIGS. 3, 4a, 4b and 5. The HW implementation presented here illustrates an example of specific types of modifications needed in one practical implementation. It is implemented based on a finite state machine (FSM) 15 that essentially realizes the present invention, if the solution is done using HW alone, incorporating major functional blocks 20, 22 and 24 of FIG. 3. One preferred way of doing this, among many others, is to embed the FSM 15 and glue logic to the peripheral logic functions of the memory die or macro (in case the memory is embedded in SoC chip) itself.

The m′×n′ logical memory array 10a refers to an idealized logical structure and not necessarily to the actual physical implementation, which is likely to be composed of several subarrays and may not include the actual spare block at all; the spare block can be also located in a register, external to the actual memory array 10a. In the current example of the m′×n′ logical memory array 10a the spare block is naturally included. The size of the logical array equals C=m′×n′ as in FIGS. 1a-d and the spare memory block consists of S elements (e.g., bits). FIG. 3 shows that the array 10a together with some peripheral circuits including address mux/demux and array drivers 10b, R/W logic means 10c, I/O bus 10e, and sense amplifiers 10d constitute the multi-element memory 10 shown in FIG. 3.

Relocation (e.g. step 52 in FIG. 4a) of the block Y:Y+S (e.g., block 17 in FIG. 1b) to the spare block M:M+S (e.g., block 18 in FIG. 1b) for hardware implementation of the present example is done as follows. Effectively, a read signal from the block 10c is provided to the block 10a to read the data from the address Y:Y+S to the sense amplifiers 10d of the memory device, and a write signal is provided by the block 10c to write the data to the spare block address M:M+S. The addresses (Y:Y+S and M:M+S) needed for this relocation are provided to the RIW logic means 10c by the FSM 15 as described below. The I/O bus 10e and R/W logic means 10c circuits generally include buffers where the read data (block Y:Y+S) can be stored while the address is changed to M:M+S and the data written back to the array 10a. Thus, the I/O bus width/buffers should be equal in size to (or larger than) the spare block size S in the preferred HW implementation, according to the present invention.

The FSM 15, as mentioned earlier, essentially incorporates major functional blocks 20, 22 and 24 of FIG. 3, according to the present invention. The timing and R/W controller 17 contains the triggering detector 20 and memory wear controller 22 with the same functions as described in regard to FIG. 3. Similarly, the signals 26 (triggering signal), 27 (further triggering signal), 30 (data relocation signal) and 32 (update signal) carry the same information and have the same origin as explained in regard to FIG. 3. The optional triggering detector 20 or memory wear controller 22 (if the detector 20 is not used) contains the necessary logic needed to define when a memory rotation is needed using different possible scenarios are described in regard to FIG. 3. Then the data relocation signal 30 contains a read/write command signal to the R/W logic means about moving the block Y:Y+S (e.g., block 17 in FIG. 1b) to the spare block M:M+S (e.g., block 18 in FIG. 1b). Thus the block 17 (timing and W/R controller) is responsible for determining the timing of said memory block relocation, but the information (pointer signal 34) about the locations of said memory blocks is provided to the block 17 (and then to the block 22) by the memory pointer controller 24 as disclosed in FIG. 3 and further discussed below.

The normal function of the timing and R/W controller 17 is performed by a regular R/W controller 17a with an input signal, a normal memory signal 17b, which depends on the memory type (e.g., clock signal), and an output signal, a normal R/W command signal 17c to the R/W logic means 10c, which facilitates the normal R/W operations of the memory 10. The signal 17b (e.g. a clock signal) can also serve as the triggering signal 26 as discussed earlier in regard to FIG. 3.

The memory pointer controller 24 effectively includes the logic and data structures needed to maintain status of the state of memory rotation and to hold the data needed for address mapping of external logic addresses to actual memory array addresses where the data requested currently resides. In particular, Y and pointer update determination means 24a, based on the updated signal form the memory wear controller 22, calculates and provides (pointer signal 34) to the timing and R/W controller 17 the physical address Y (and optionally M, if required, depending on the implementation as discussed earlier) to be accessed for enabling an at least one further data relocation of the data located at the physical address Y of the array 10a to the spare block with the address M as discussed above. After each memory relocation, means 24a updates the spare block location M in a spare block address register 24b.

The spare block address information from the spare block address register 24b is used by a m′×n′ address mapping counter 24c to map the correct location of the memory elements accessed by the user, who sends the address signal 24d as a part of the normal memory operation. This mapping procedures is described in details in FIGS. 2a-2c. Thus the block 10b (mux/demux and array drivers) receives an FSM modified address signal 24e with the correct memory address entered by the user.

It should be noted that the HW implementation is strongly dependent on the type of memory device and can be implemented using other electronic devices operating with the same fundamental logical principle but differing in details determined by the specific memory technology. For sector addressed memories like NAND Flash, the implementation would be quite different, and a pure HW solution is probably not the preferred way. Also, if the memory cell can withstand a relatively small amount of reads or writes or erases, thousands or millions, the present invention can be used with care because of the wear overhead that every cell experiences. The HW implementation is more useful if the memory can withstand several billions or more accesses/cell, because then the “hot-spot leveling” effect is dominating over the wear overhead. This makes it appealing especially to the new NVRAM type memories like FeRAM, Ovonics Unified Memory, etc. and especially read destructive wearing memories (again FeRAM).

1. A method for wear leveling of a multi-block memory (10) containing data, usable in multi-block memory (10) activities, comprising the steps of:
detecting (42, 42a) an at least one triggering signal (26); and
copying or relocating (52, 52a) the data of an at least one first memory block (17) containing an at least one memory element of the multi-block memory (10) to an at least one second memory block (18) of the multi-block memory (10) after detecting (42, 42a) the at least one triggering signal, wherein said at least one second memory block (18) does not contain said data before said copying or relocating.

2. The method according to claim 1, wherein each of the at least one first memory block (17) and the at least one second memory block (18) contains only one memory element.

3. The method according to claim 1, further comprising the step of:
updating (54) a first memory pointer (M) originally pointed to the at least one second memory block (18) before said copying or relocating to point to the at least one first memory block (17) after said copying or relocating.

4. The method according to claim 3, further comprising the step of:
updating (58) a second memory pointer (Z) by shifting it back to a physical zero point (Z₀) by reducing the value of the second memory pointer (Z) by a number of relocated memory elements of the second memory block (18) if the first memory pointer (M) is pointing to one of the memory elements of the at least one second memory block (18) after said updating.

5. The method according to claim 1, wherein there is more than one memory element contained in the at least one first memory block (17) and there is more than one memory element contained in the at least one second memory block (18), respectively.

6. The method according to claim 1, wherein the data of an at least one additional block of the multi-block memory (10) is relocated to an at least one further additional block of the multi-block memory (10) after detecting (42, 42a) the at least one triggering signal, wherein said at least one further additional block does not contain the data before said relocation.

7. The method according to claim 1, wherein said copying or relocating is performed according to predetermined criteria.

8. The method according to claim 7, wherein said predetermined criteria enables said copying or relocating of a regular pattern such that after a predetermined number of triggering signals (26), copying or relocating steps are identical.

9. The method according to claim 7, wherein said predetermined criteria enables said copying or relocating of a random pattern such that after any number of triggering signals (26), copying or relocating steps are not necessarily identical.

10. The method according to claim 1, wherein said copying or relocating (52, 52a) of the data occurs only after detecting a predetermined number of the at least one triggering signal (26).

11. The method according to claim 1, wherein the at least one triggering signal (26) corresponds to a read operation.

12. The method according to claim 1, wherein the at least one triggering signal (26) corresponds to a write operation.

13. The method according to claim 1, wherein the at least one triggering signal (26) is a time clock pulse.

14. The method according to claim 1, wherein the at least one triggering signal (26) corresponds to the detection of a predetermined number of read/write operations or clock pulses.

15. The method according to claim 1, wherein said copying or relocating (52, 52a) of the data occurs a predetermined number of times between the triggering signals.

16. The method according to claim 1, further comprising the step of:
counting the usage of the individual memory blocks of the multi-block memory (10);
wherein said copying or relocating is performed according to predetermined criteria, said predetermined criteria includes considerations for said counting.

17 The method according to claim 1, wherein all the data contained in the multi-block memory (10) is copied or relocated at the same time.

18. The method according to claim 1, further comprising the step of:
updating a variable logical address X after said copying or relocating in the multi-block memory (10) containing C memory elements, said variable logical address X for said C memory elements identified by pointers X₀, X₁ . . . Xₖ, Xₖ₊₁ . . . X_{C-1} is updated to an updated variable logical address Xᵤ for C-S memory elements identified by the pointers X₀, X₁ . . . Xₖ₋₁, X_{k+S} . . . X_{C-1}, wherein C is a total number of the memory elements of the multi-element memory (10), S is a number of the memory elements identified by the pointers Xₖ, Xₖ₊₁, . . . X_{k+S-1} in a spare memory block after said copying or relocating, wherein a first element of said first memory block (17) after said copying or relocating corresponds to a first element identified by the pointer Xₖ of the spare memory spare block after said copying or relocating.

19. The method according to claim 1 wherein at least one memory pointer pointing to said first memory block before said copying or relocating is updated to point to said second memory block after said copying or relocating.

20. An electronic device (11), comprising:
a multi-block memory (10) containing data, usable in multi-block memory (10) activities;
a memory wear controller (22), responsive to a triggering signal (26) or to a further triggering signal (26a), for providing a data-relocation signal (30) to the multi-block memory (10) to relocate the data from an at least one first memory block (17) containing an at least one memory element of the multi-block memory (10) to an at least one second memory block (18) of the multi-block memory (10) wherein said at least one second memory block (18) does not contain said data before said copying or relocating, and for providing an update signal (32) after performing said copying or relocating; and
a memory pointer controller (24), responsive to the update signal (32).

21. The electronic device (11) of claim 20, wherein the memory pointer controller (24) provides a pointer signal (34) to the memory wear controller (22) based on predetermined criteria.

22. The electronic device (11) of claim 21, wherein the memory pointer signal (34) contains a physical address (Y) in the multi-block memory (10) to be accessed for enabling an at least one further data relocation of the data located at the physical address (Y) and optionally an address of a first memory pointer M.

23. The electronic device (11) of claim 20, wherein the memory pointer controller (24) provides updating of at least one memory pointer pointing to said first memory block before said copying or relocating to point to said second memory block after said copying or relocating.

24. The electronic device (11) of claim 20, wherein the memory wear controller (22) and the memory pointer controller (24) are implemented as a combination of software and hardware components.

25. The electronic device (11) of claim 20, wherein the memory wear controller (22) and the memory pointer controller (24) are implemented as hardware.

26. The electronic device (11) of claim 25, wherein the hardware is implemented using a finite state machine (15).

27. The electronic device (11) of claim 20, wherein the memory wear controller (22) and the memory pointer controller (24) are implemented as software.

28. The method according to claim 20, wherein each of the at least one first memory block (17) and the at least one second memory block (18) contains only one memory element.

29. The electronic device (11) of claim 20, wherein there is more than one memory element contained in the at least one first memory block (17) and there is more than one memory element contained in the at least one second memory block (18), respectively.

30. The electronic device (11) of claim 20, wherein said copying or relocating of the data from the at least one first memory block (17) and updating the location of the memory pointers (M, Z) are performed according to predetermined criteria.

31. The electronic device (11) of claim 20, further comprising a triggering detector (20), responsive to the triggering signal (26), for providing a further triggering signal (26a) upon detecting the triggering signal (26).

32. An electronic device, comprising:
means for containing data in multiple memory blocks, wherein said data is usable in activities of the means for containing data;
means for providing a data-relocation signal to the means for containing the data for copying or relocating the data from an at least one first memory block containing an at least one memory element of the means for containing the data to an at least one second memory block of the means for containing the data in response to a triggering signal, wherein said at least one second memory block does not contain said data before said copying or relocating, and for providing an update signal on a status of the means for containing the data after performing said copying or relocating; and
means for providing to the means for providing the data-relocation signal, in response to the update signal, a pointer signal containing a physical address pointer (Y) in means for containing data to be accessed for enabling an at least one further data relocation of the data located at the physical address (Y) and optionally an address of a first memory pointer (M).

33. The method according to claim 1, wherein the means for providing to the means providing the data-relocation signal further provides updating of at least one memory pointer pointing to said first memory block before said copying or relocating to point to said second memory block after said copying or relocating.

34. A method for wear leveling of a multi-block memory containing data, usable in multi-block memory activities, in which method said data is copied or relocated from an at least one first block containing an at least one memory element of the multi-block memory to an at least one second block containing an at least one memory element of the multi-block memory after detecting a triggering signal related to said data, wherein said at least one second block does not contain said data before said copying or relocating.

35. The method according to claim 34, wherein at least one memory pointer pointing to said first memory block before said copying or relocating is updated to point to said second memory block after said copying or relocating.
